(19) United States
(12) Patent Application Publication
(10) Pub. No.: US 2026/0046171 A1
(43) Pub. Date: Feb. 12, 2026

(54) AI CHANNEL PREDICTION USING PATH-BASED TRACKING

(71) Applicant: Samsung Electronics Co., Ltd., Suwon-si (KR)

(72) Inventors: Yu Zhang, Frisco, TX (US); Daoud Burghal, San Jose, CA (US); Hao Chen, Allen, TX (US); Yan Xin, Princeton, NJ (US); Fan Zhang, Plano, TX (US); Yunseong Cho, Frisco, TX (US); Yang Li, Plano, TX (US)

(21) Appl. No.: 19/189,187

(22) Filed: Apr. 24, 2025

Related U.S. Application Data
(60) Provisional application No. 63/682,145, filed on Aug. 12, 2024.

(51) Int. Cl. H04L 25/02; H04B 17/391

(52) U.S. Cl. CPC H04L 25/0224; H04B 17/3913

(57) ABSTRACT

Methods and apparatuses for an AI channel prediction using a path-based tracking in wireless communication systems are provided. The methods of BS comprise: receiving one or more SRSs; identifying, based on the one or more SRSs, path clusters of channel instances, wherein each of the path clusters includes a group of paths that have associated impinging angles and propagation delays, respectively; identifying, based on a set of pixels in a channel image, a path from the path clusters; and performing, based on the identified path, a channel tracking operation.

### CROSS-REFERENCE TO RELATED APPLICATIONS AND CLAIM OF PRIORITY

The present application claims priority to U.S. Provisional Patent Application No. 63/682,145, filed on Aug. 12, 2024. The contents of the above-identified patent documents are incorporated herein by reference.

### TECHNICAL FIELD

The present disclosure relates generally to wireless communication systems and, more specifically, the present disclosure relates to an artificial intelligence (AI) channel prediction using a path-based tracking in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to an AI channel prediction using a path-based tracking in wireless communication systems.

In one embodiment, a base station (BS) in a wireless communication system is provided. The BS comprises a transceiver configured to receive one or more sounding reference signals (SRSs). The BS further comprises a processor operably coupled to the transceiver, the processor configured to: identify, based on the one or more SRSs, path clusters of channel instances, wherein each of the path clusters includes a group of paths that have associated impinging angles and propagation delays, respectively, identify, based on a set of pixels in a channel image, a path from the path clusters, and perform, based on the identified path, a channel tracking operation.

In another embodiment, a method of a BS in a wireless communication system is provided. The method comprises: receiving one or more SRSs; identifying, based on the one or more SRSs, path clusters of channel instances, wherein each of the path clusters includes a group of paths that have associated impinging angles and propagation delays, respectively; identifying, based on a set of pixels in a channel image, a path from the path clusters; and performing, based on the identified path, a channel tracking operation.

In yet another embodiment, a non-transitory computer-readable medium comprising program code is provided. The non-transitory computer-readable medium comprising program code, that when executed by at least one processor, causes an electronic device to: receive one or more SRSs; identify, based on the one or more SRSs, path clusters of channel instances, wherein each of the path clusters includes a group of paths that have associated impinging angles and propagation delays, respectively, identify, based on a set of pixels in a channel image, a path from the path clusters; and perform, based on the identified path, a channel tracking operation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate examples of wireless transmit and receive paths according to various embodiments of the present disclosure;

FIG. 6 illustrates an example of antenna structure according to various embodiments of the present disclosure;

FIG. 7 illustrates an example of processing delay between the SRS channel estimation block and the downstream DSP block according to various embodiments of the present disclosure;

FIG. 8 illustrates an example of path-cluster-based SRS channel tracking procedure according to various embodiments of the present disclosure;

FIG. 9 illustrates an example of training sample comprising channel values at a specific pixel according to various embodiments of the present disclosure;

FIG. 10 illustrates an example of AI-based channel prediction according to various embodiments of the present disclosure;

FIG. 11 illustrates an example of channel image truncation according to various embodiments of the present disclosure;

FIG. 12 illustrates an example of dominant path tracking according to various embodiments of the present disclosure; and

FIG. 13 illustrates a flowchart of BS method for an AI channel prediction using a path-based tracking in wireless communication systems according to various embodiments of the present disclosure.

### DETAILED DESCRIPTION

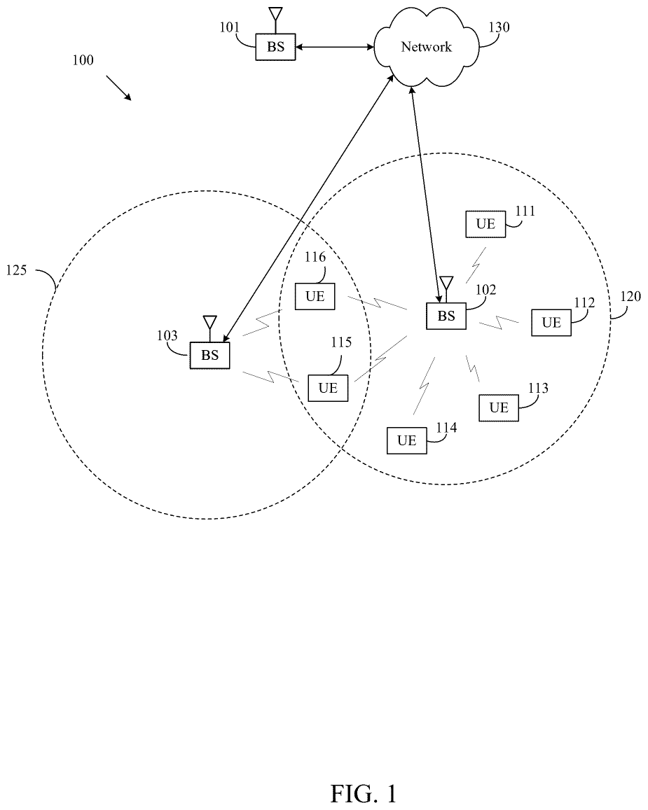

FIG. 1 through FIG. 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v17.4.0, “NR; Physical channels and modulation”; 3GPP TS 38.331 v17.3.0, “NR; Radio Resource Control (RRC) protocol specification”; 3GPP, TS 38.321, v.16.1.0 “NR; Medium Access Control (MAC); Protocol specification”; and 3GPP, TS 38.214, v.16.2.0. “NR; Physical layer procedures for data. ”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device. ” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof. In certain embodiments, and one or more of the gNBs 101-103 includes circuitry, programing, or a combination thereof, to support an AI channel prediction using a path-based tracking in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

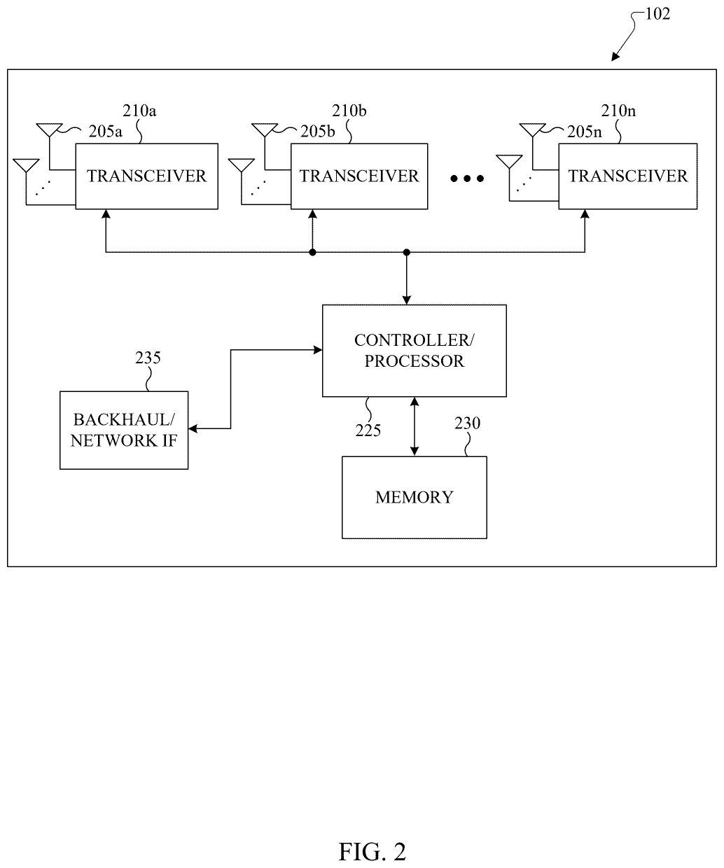

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support an AI channel prediction using a path-based tracking in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

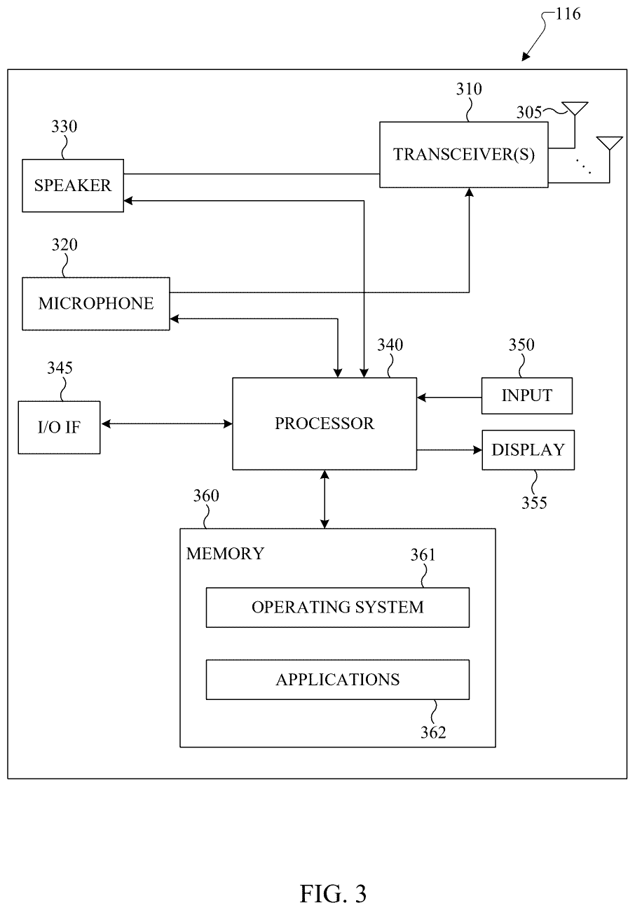

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to provide information or signal for the gNB 101-103 supporting an AI channel prediction using a path-based tracking in wireless communication systems.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

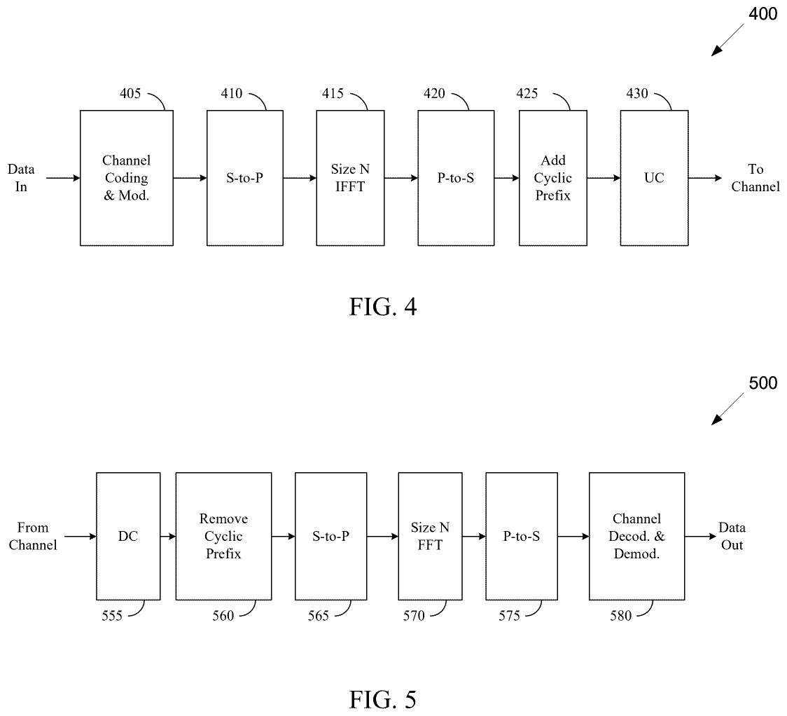

FIG. 4 and FIG. 5 illustrate example wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process may comprise NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

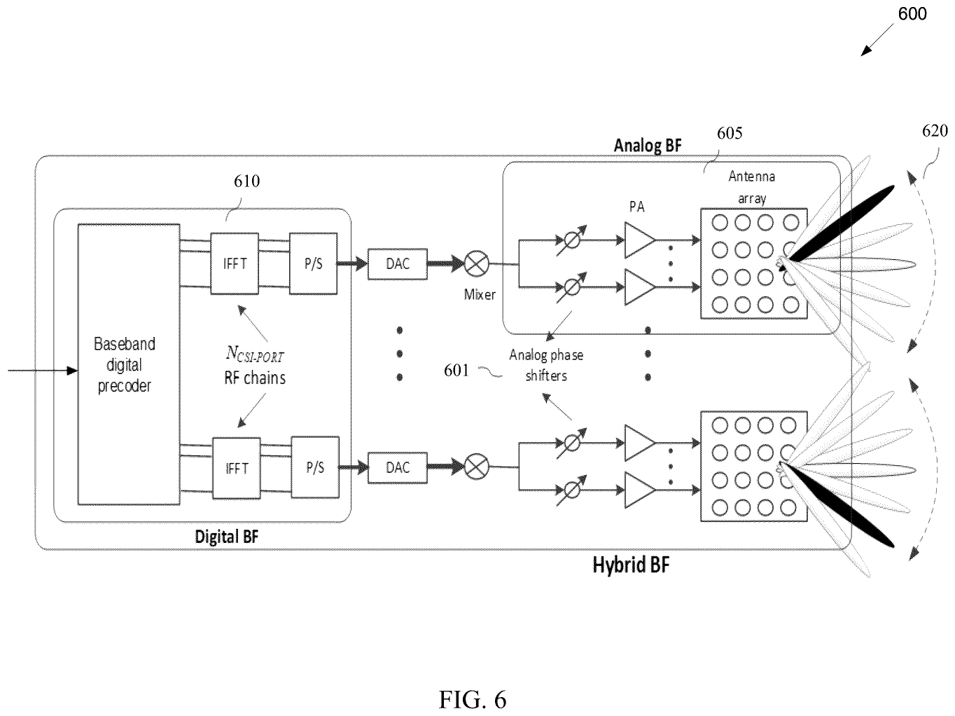

Rel. 14 LTE and Rel. 15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports - which can correspond to the number of digitally precoded ports—tends to be limited due to hardware constraints (such as the feasibility to install a large number of ADCs/DACs at mmWave frequencies) as illustrated in FIG. 6.

FIG. 6 illustrates an example antenna structure 600 according to various embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration - to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be needed to compensate for the additional path loss.

A massive MIMO (mMIMO) is an important technology to improve the spectral efficiency of 5G and beyond cellular networks. The number of antennas in mMIMO is typically much larger than a number of UEs, which allows BS to perform multi-user DL precoding to schedule parallel data transmissions on the same time-frequency resources. However, its performance depends heavily on the quality of channel state information (CSI) at BS.

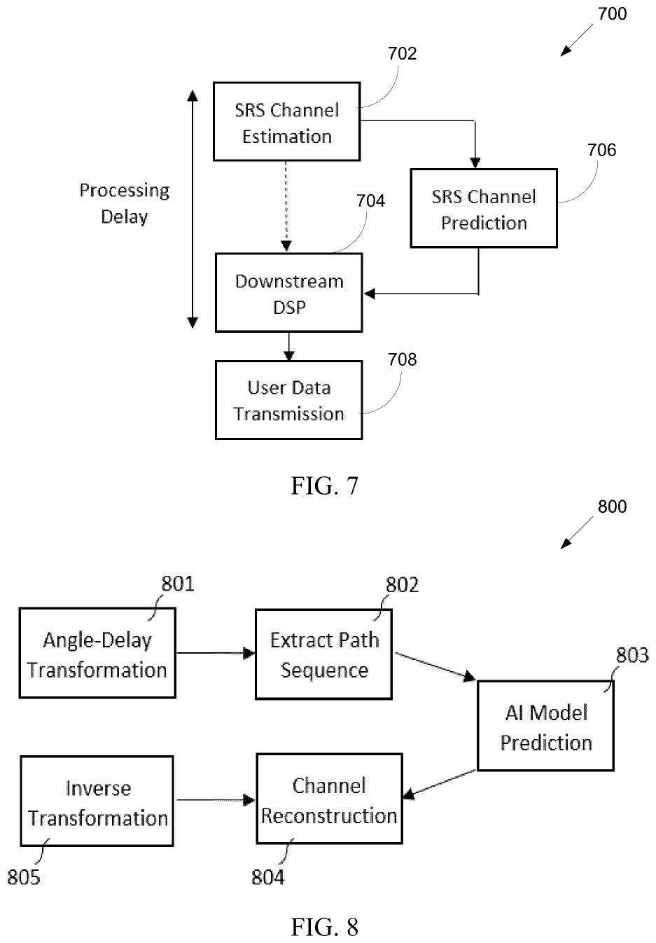

FIG. 7 illustrates an example of processing delay 700 between the SRS channel estimation block and the downstream DSP block according to various embodiments of the present disclosure. An embodiment of the processing delay 700 shown in FIG. 7 is for illustration only.

It has been recently verified that the multi-user (MU)-MIMO (MU-MIMO) performance degrades with UE mobility. As shown in FIG. 7, there is a normally noticeable processing delay (e.g., in the level of a few milliseconds) between the SRS channel estimation module (where the SRS channel is obtained) and the finish point of all the downstream digital signal processing (DSP). This likely makes the transmission design outdated since the UEs' channels have been changed during this time period, hence incurring performance loss. An SRS channel prediction module can be used to combat the CSI aging, thus, the system can reduce the impact of processing delay and possibly the overhead. These problems are important to address especially at higher UE mobilities.

As illustrated in FIG. 7, the processing delay may be identified between the SRS channel estimation block (702) and the downstream DSP block (704). In addition, the SRS channel prediction block (706) may be placed between the SRS channel estimation block (702) and the downstream DSP block (704). After identifying the processing delay, the signal is transmitted in the user data transmission block (708).

Data-driven (e.g., AI-based) approaches can be utilized for CSI prediction, allowing model flexibility and applicability to the environment of interest. AI-based channel prediction is one of the promising study cases in 3GPP standard committee. Some implementations of CSI prediction technologies consider channel instance as images. Such interpretation, however, oftentimes lacks a useful visual meaning and hence making the developed prediction solutions somehow far-fetched. In addition, the training of these models may require a large dataset, undermining their practicality.

The present disclosure provides a technique to enhance the generalizability of data-driven CSI prediction and to reduce the requirement on the dataset. A dominant path extraction method is also provided which is used for determining the portion of the channel image to track.

The channel state information becomes outdated quickly in highly dynamic environments. The problem is more severe for mMIMO systems in which the BS relies on sounding reference signal sent by a UE in the network to estimate the uplink channel. The UE also relies on scheduled pilot transmission (e.g., CSI-RS) by the BS to estimate the downlink channel. This greatly reduces the performance of mMIMO MU-MIMO transmission with mobile UEs or highly dynamic environment. Other model-based solutions rely on accurate modelling of the system.

In contrast, the data-driven approaches are able to learn the channel structure directly from the environment of interest. However, other data-driven solutions normally model the channels as images, which in some cases is not appropriate and is less flexible. As a result, it becomes harder for the developed solutions to generalize and it also may require a large dataset to train. The present disclosure provides solutions to the channel prediction problem from different angles, (i) channel prediction is performed on the pixel level, and (ii) method to determine dominant paths.

In one embodiment, path-based channel training dataset construction and AI model training are provided, applying channel tracking based on one or more path clusters of one or more wireless channel instances. In such embodiment, each path cluster is a group of paths that have similar impinging angles and propagation delays.

In another embodiment, a dominant path extraction is provided, extracting a dominant path based on a determination of a set of pixels in a channel image for an AI model to track.

In yet another embodiment, adjustable inference complexity is provided, adjusting dynamically a computation complexity during an inference to satisfy one or more specific requirements of a deployment hardware or software based on increasing or decreasing a number of tracking paths.

The present disclosure provides: (1) channel transformation, prediction and reconstruction modules, and (2) a dominant path determination module, and (3) a CSI interpolation module. In the present disclosure, the module can be implemented as at least one of software, hardware, or firmware.

The present discloses provides a channel prediction method and apparatus for mMIMO systems with mobility. Embodiments of the present disclosure apply channel tracking based on path cluster (i.e., a group of paths that have similar impinging angles and propagation delays) of the wireless channel instances. The embodiments as disclosed in the present disclosure fully respect the underlying wireless propagation mechanism, and achieve high channel prediction accuracy. In addition, by fully leveraging the potential sparsity in the cluster domain, the path-based channel prediction framework is scalable to systems with large antenna arrays and large bandwidth, and the path-based channel prediction framework possesses high flexibility in maintaining complexity requirements.

The SRS is an uplink reference signal that is used for uplink channel acquisition. A periodic SRS setting meaning that the UE is transmitting SRS in a periodic manner is provided. By processing the received SRS, the BS is able to estimate the CSI based on which the subsequent functionalities (such as UE scheduling, precoding, etc.) can be executed. The SRS channel prediction plays an important role in mitigating the channel aging effect that is caused by system processing delays and environment dynamics, and the SRS channel prediction may be implemented in a critical signal processing module in the commercial mMIMO system.

FIG. 8 illustrates an example of path-cluster-based SRS channel tracking procedure 800 according to various embodiments of the present disclosure. The path-cluster-based SRS channel tracking procedure 800 as may be performed by a BS (e.g., 101-103 as illustrated in FIG. 1). An embodiment of the path-cluster-based SRS channel tracking procedure 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

The overall flow of the path-cluster-based SRS channel tracking procedure is provided in FIG. 8. For clarity, in the following discussions, “path-cluster-based” and “path-based” can be interchangeably used to refer the same idea. To be more specific, the SRS channel is originally estimated in the antenna-frequency domain in a MIMO-OFDM system based on the uplink pilot sequences transmitted by the UE devices. Other approaches oftentimes suggest that it is more efficient when processing the SRS CSI samples in the angle-delay domain for full utilization of the possible sparse structure.

The common practice and the estimated SRS channel samples may be transformed into angle-delay domain for further processing (801).

Some data-driven channel prediction approaches consider the complex-valued SRS channel matrix at a given time as a 2D image. However, such image interpretation of the wireless channel lacks useful visual meaning. In contrast, it may be found that it may be somehow beneficial to process each pixel of such “image” independently, since each pixel has more clear physical meaning in this context. Therefore, a module is adopted to extract the path sequence from the sequence of channel images in the angle-delay domain (802).

The AI model is leveraged to make such a prediction, i.e., inferring the future values of a pixel from its historical values (803). Each pixel is processed independently (hence supporting parallelization for fast inference) and the predicted pixels may be collected together to form the reconstructed channel image (804). Finally, the inverse transformation is applied to convert the angle-delay channel back to its original antenna-frequency format for subsequent usages (805).

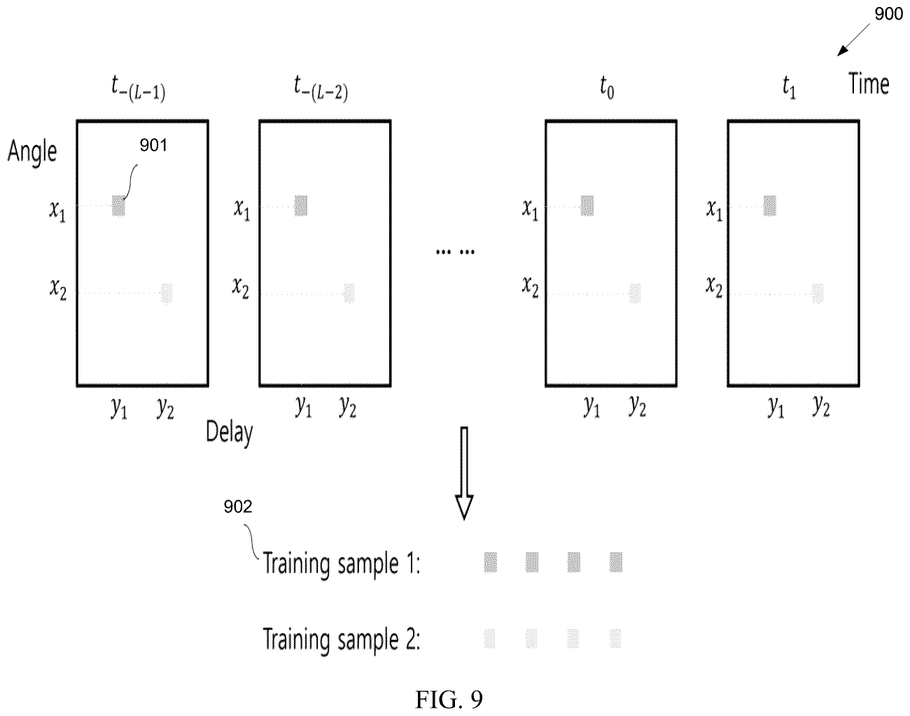

The provided path-cluster-based channel prediction solution uses a different dataset construction method. As aforementioned, the prediction unit changes from a channel image (as used by other approaches) to a channel pixel. Correspondingly, each training sample (including the input and output of the AI model) comprises channel values at a specific pixel as illustrated in FIG. 9.

FIG. 9 illustrates an example of training sample comprising channel values at a specific pixel 900 according to various embodiments of the present disclosure. An embodiment of the training sample comprising channel values at a specific pixel 900 shown in FIG. 9 is for illustration only.

The angle-delay domain channel image has a size (or resolution) of 2×Nₐₙₜ×N_{rb}, where Nₐₙₜ denotes the number of antennas, N_{rb} denotes the number of RBs, the leading dimension 2 is the real and imaginary separation of the original complex-valued channel (or oftentimes interpreted as the color channel in the context of image). Each pixel of such channel image represents the channel with the corresponding angle and delay (901), which is essentially the superposition of paths having similar impinging angles and propagation delays that fall within the same FFT bin. The sequence of the channel values at the same pixel position at different time steps constructs a time-series that forms as one training sample as the provided path-based AI model (902).

The path-based dataset generation approach enhances the training dataset quality (and thus the learning experience) from the following perspectives.

First, a total number of training samples is drastically increased due to the path-based dataset composition. For instance, compared to the other channel dataset generation methods that treat each channel instance as an image, the aforementioned training sample generation solution produces a dataset whose size is up to Nₐₙₜ×N_{rb} times of its counterpart.

Second, as aforementioned, each pixel includes the combined channel effect that is the superposition of a group of paths coming from similar angles and having similar propagation delays. Different pixels, therefore, end up having rather different Doppler compositions due to the distinct difference on angle and delay, improving the diversity of the generated path-based dataset. A unified model trained based on such dataset is expected to have better generalization capacity.

Third, from the data collection perspective, it may be impossible to have UEs moving at the exactly same speed during throughout the collection process. The non-constant moving speed may have more impact on the image-based dataset. For the path-based dataset generation, it is somehow not an issue as long as the speed limit is known and controlled.

Fourth, during the dataset generation process, the pixels with very small channel powers can be removed. This helps eliminate the irrelevant information (since the channel values at those pixels may just be noise) and improve the dataset quality.

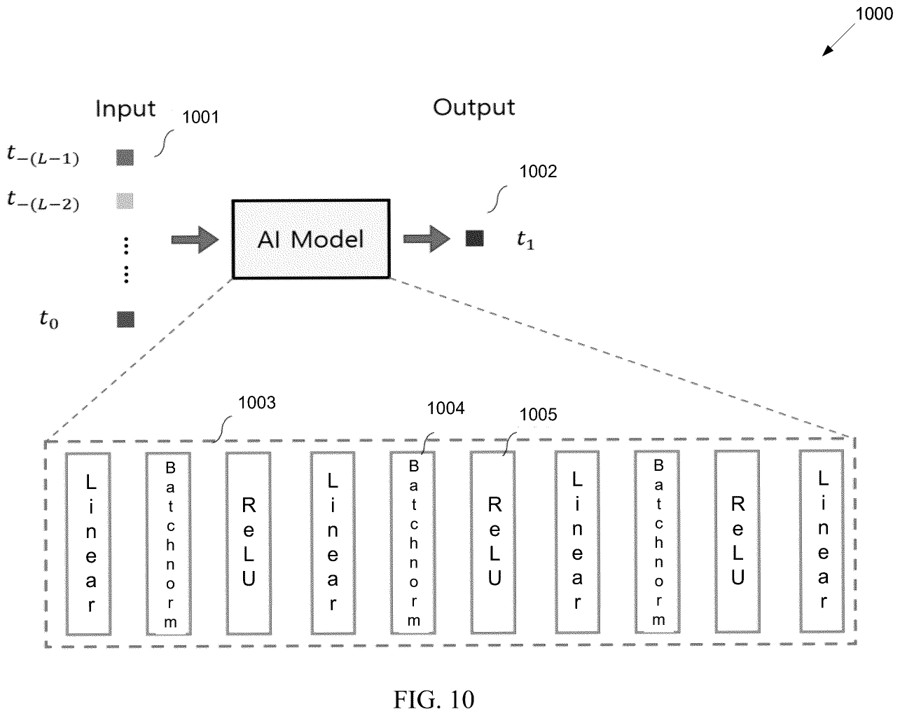

FIG. 10 illustrates an example of AI-based channel prediction 1000 according to various embodiments of the present disclosure. An embodiment of the AI-based channel prediction 1000 shown in FIG. 10 is for illustration only.

FIG. 10 illustrates the general structure of the provided AI-based channel prediction module. The model takes the historical channel values at a given pixel as input (1001) and predicts its values in the future (1002). Different AI model architectures have been explored to perform such prediction tasks, and the simulation results suggested that the multi-layer perceptron (MLP) network presents the best generalization performance among the explored ones on the used channel dataset.

The adopted MLP-based neural network has a standard architecture where three hidden layers are used (1003). The batch normalization is leveraged between hidden layers (1004). The non-linearity is provided by the rectified linear unit (ReLU) layers (1005). The input size of the AI model is 2 times the observation length, and the output size of the AI model is 2 times prediction length.

It is worth clarifying that the claim regarding the best model architecture for this task may not be conclusive, and there may be other architectures (either with totally different neural network classes or adjustments on the model hyperparameters) with better performance either on the same dataset or on different simulated/real-measurement datasets. The constructed path dataset and the generic training and inference procedure, however, do not expect to change significantly, which makes it convenient to have other models to be plugged in (i.e., fast algorithm upgrade) and the key ideas presented in the present disclosure for all.

One of the major advantages of the provided path-based channel prediction method is its high flexibility during deployment stage. Specifically, the provided algorithm in the present disclosure provides the possibility of dynamically adjusting the computation complexity during the inference to meet specific requirements of the deployment hardware/software. This is achieved by increasing or decreasing the number of tracking paths. As can be inferred, with more tracking paths, the reconstructed channels normally have higher accuracy. The downside, however, is the increased computations, which may lead to higher power consumption and processing delay.

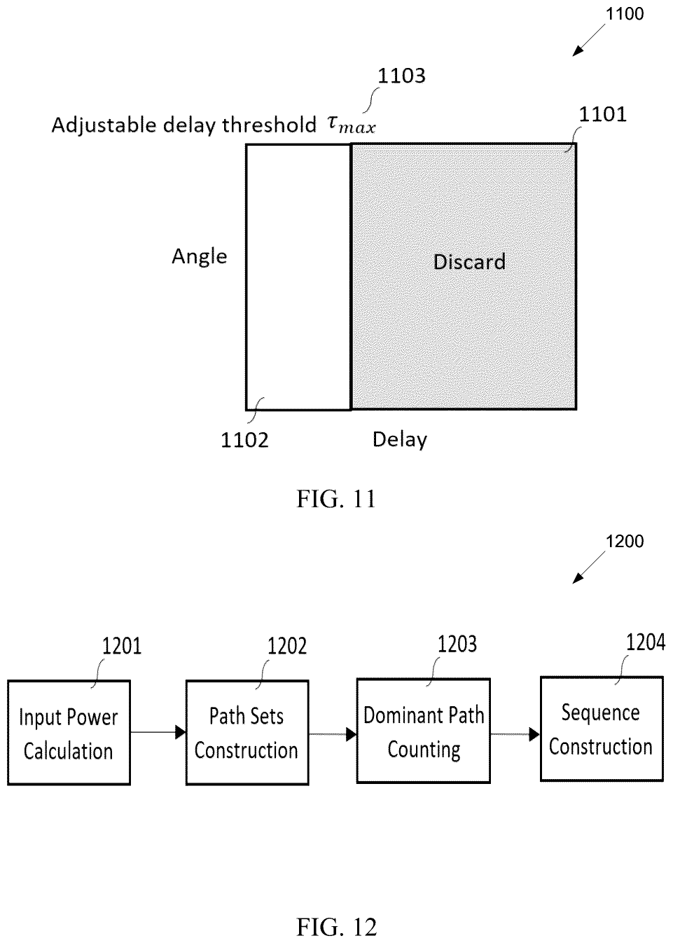

FIG. 11 illustrates an example of channel image truncation 1100 according to various embodiments of the present disclosure. An embodiment of the channel image truncation 1100 shown in FIG. 11 is for illustration only.

In one embodiment, a channel image truncation is provided. In such embodiment, there are multiple ways to reduce the total number of tracking paths. One example is to discard the latter part of the angle-delay channel image as it normally contains large portion of near-zero values due to the finite delay spread (1101). In other words, the channel prediction is only performed on the former part of the channel image (1102). A control parameter called “adjustable delay threshold,” i.e., τₘₐₓ, can be used to dynamically control the total number tracked paths (1103). After the prediction is done, zeros may be appended to the predicted part, and the whole image may be converted to the antenna-frequency domain via inverse transformation.

In one embodiment, to be more flexible, a dominant path extraction algorithm that determines the set of pixels in the channel image for the AI model to track is provided. The motivation for this algorithm is that the dominant paths are normally distributed across the image. This means that the former part of the channel image may still contain certain amount of near-zero channel values while the latter part may also contain a few pixels with strong power. As a result, it may be more appropriate to track the dominant paths instead of simply truncating the channel image. In addition, it allows selecting arbitrary number of tracking paths, which is more flexible in some cases.

FIG. 12 illustrates an examples of dominant path tracking 1200 according to various embodiments of the present disclosure. The dominant path tracking 1200 as may be performed by a BS (e.g., 101-103 as illustrated in FIG. 1). An embodiment of the dominant path tracking 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

The overall procedure of the dominant path tracking is highlighted in FIG. 12. Moreover, throughout the remaining discussions, it may be assumed that the SRS channels are already in the angle-delay domain, and a total number of K paths may be returned by the algorithm.

As illustrated in FIG. 12, the input of the dominant path tracking module is the sequence of the observed SRS channels, denoted as \tilde{X}, which has a size of T×P, where T is the sequence length and P is the total number of paths (or more accurately, angle-delay bins) in the channel image (e.g., P=Nₐₙₜ×N_{rb}). Since only channel power is of concern, the algorithm starts with calculating the element-wise magnitude of \tilde{X} in 1201.

This essentially transforms the complex-valued matrix \tilde{X} into a real-valued matrix with the same shape, denoted as X. Each row of X is essentially a flattened version of the channel image and it contains the channel values for different paths at a given time step. For the t-th row, a set of path indices is returned based on the top-K channel powers. Such set may be denoted as Sₜ. A total number of T path sets may be produced since the sequence length is T. This finishes the second step of the algorithm in 1202. As can be inferred, the dominant paths may appear in most of these path sets. Therefore, based on the T path sets, i.e., S₁, S₂, . . . , S_{T}, the appearance of each unique path is counted in 1203. Based on the counting results, the K paths with the most frequent appearance may be the identified dominant paths. Finally, the K columns of \tilde{X} (where each column is essentially a time series) corresponding to the dominant path locations may be returned by the algorithm in 1204.

The provided path-cluster-based SRS channel prediction method can be conveniently extended to perform channel interpolation task, where the channels between two SRSs are predicted. It is worth highlighting that both the dataset generation process and AI model architecture are similar to the SRS prediction task. Specifically, the input of the model is the past and future (during the inference, this may be the predicted SRSs) SRS channel values. For example, 10 past SRS values with 2 future SRS values. The output of the model is the TTI level channel values in between the 2 future SRSs, which represent the interpolated channels. The channel reconstruction process based on the predicted TTI level channel values is also similar to the reconstruction process described before. It is worth highlighting that this does not exclude the method that uses an image-based AI model to perform the channel interpolation if it is preferable to do so.

### Leveraging Long Csi Observation Window (highly Accurate Csi Prediction)

The provided path-cluster-based SRS channel prediction method is able to conduct prediction based on long CSI observation windows. This is typically not affordable with solutions that process the whole channel images at once, due to the high computation and memory consumptions. By contrast, the additional resources required by the provided prediction method when increasing the observation window is manageable. It is worth highlighting that using long CSI observation windows is an effective way in mitigating the sparsity of the SRS in time domain and in addressing the environment with rich multi-path propagation. As a result, the provided path-cluster-based SRS channel prediction method can significantly improve the system performance in these challenging scenarios.

Enabling accurate channel prediction and supporting flexible deployment are critical for practical massive MIMO systems. In one embodiment, the provided path-cluster-based channel prediction solution has broad use cases: (1) enabling robust MU-MIMO system with improved cell throughput performance; and (2) enhancing the communication for high dynamic systems, e.g., vehicular to everything (V2X), which is crucial for applications such as autonomous driving, etc.

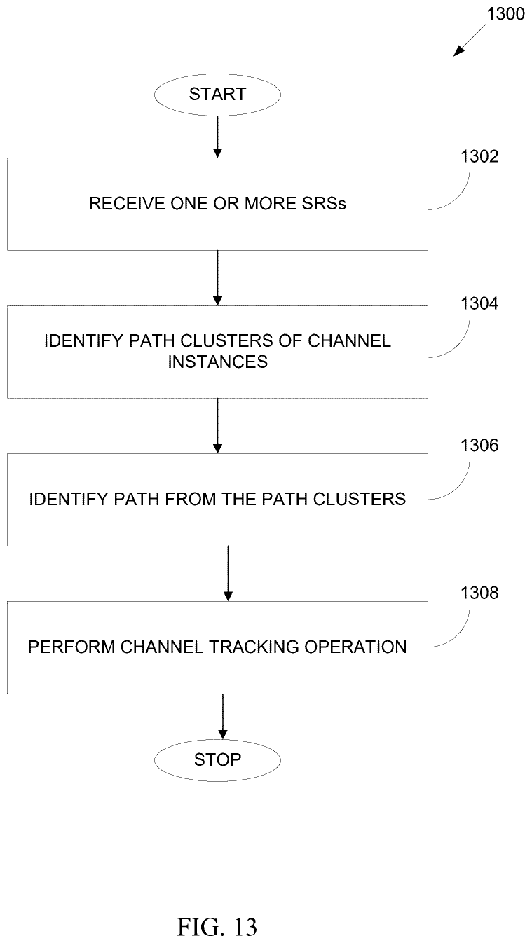

FIG. 13 illustrates a flowchart of BS method 1300 for an AI channel prediction using a path-based tracking in wireless communication systems according to various embodiments of the present disclosure. The BS method 1300 as may be performed by a BS (e.g., 101-103 as illustrated in FIG. 1). An embodiment of the BS method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

As illustrated in FIG. 13, the method 1300 begins in step 1302. In step 1302, a BS receives one or more SRSs.

In step 1304, the BS identifies, based on the one or more SRSs, path clusters of channel instances, wherein each of the path clusters includes a group of paths that have associated impinging angles and propagation delays, respectively.

In step 1306, the BS identifies, based on a set of pixels in a channel image, a path from the path clusters.

In step 1308, the BS performs, based on the identified path, a channel tracking operation.

In one embodiment, the BS identifies the set of pixels in an impinging angle domain and a propagation delay domain. In such embodiment, each pixel in the set of pixels is separately processed for the path clusters.

In such embodiment, the channel tracking operation is performed in an antenna-frequency domain, an angle-delay domain, and a path-cluster domain, an SRS channel estimation and an SRS channel usage are performed in the antenna-frequency domain, an angle-delay transformation and an inverse transformation are performed in the angle-delay domain, and a channel reconstruction operation is performed, based on an AI prediction model, using a path sequence in the path-cluster domain.

In one embodiment, the BS identifies the set of pixels in the channel image during an observation window time, performs, based on the set of pixels identified during the observation window time, a prediction operation for the set of pixels in the channel image during a prediction window time, and generates, based on the set of pixels and the predicted set of pixels, a set of training samples for the AI prediction model.

In such embodiments, the observation window time is associated with a CSI observation window time in order to reduce a sparsity of the one or more SRSs in a time domain.

In one embodiment, the BS identifies a delay threshold in a delay domain to adjust a number of tracking paths for the channel tracking operation and removes near-zero channel values in the channel image, the near-zero channel values being identified as channel values exceeding the delay threshold.

In one embodiment, the BS identifies, based on power of the set of pixels in the channel images, the identified path from the path clusters; and generates, based on the identified path, a sequence for the channel tracking operation.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver configured to receive one or more sounding reference signals (SRSs); and
a processor operably coupled to the transceiver, the processor configured to:
identify, based on the one or more SRSs, path clusters of channel instances, wherein each of the path clusters includes a group of paths that have associated impinging angles and propagation delays, respectively,
identify, based on a set of pixels in a channel image, a path from the path clusters, and
perform, based on the identified path, a channel tracking operation.

2. The BS of claim 1, wherein the processor is further configured to identify the set of pixels in an impinging angle domain and a propagation delay domain, and
wherein each pixel in the set of pixels is separately processed for the path clusters.

3. The BS of claim 1, wherein:
the channel tracking operation is performed in an antenna-frequency domain, an angle-delay domain, and a path-cluster domain;
an SRS channel estimation and an SRS channel usage are performed in the antenna-frequency domain;
an angle-delay transformation and an inverse transformation are performed in the angle-delay domain; and
a channel reconstruction operation is performed, based on an artificial intelligence (AI) prediction model, using a path sequence in the path-cluster domain.

4. The BS of claim 3, wherein the processor is further configured to:
identify the set of pixels in the channel image during an observation window time;
perform, based on the set of pixels identified during the observation window time, a prediction operation for the set of pixels in the channel image during a prediction window time; and
generate, based on the set of pixels and the predicted set of pixels, a set of training samples for the AI prediction model.

5. The BS of claim 4, wherein the observation window time is associated with a channel state information (CSI) observation window time in order to reduce a sparsity of the one or more SRSs in a time domain.

6. The BS of claim 1, wherein the processor is further configured to:
identify a delay threshold in a delay domain to adjust a number of tracking paths for the channel tracking operation; and
remove near-zero channel values in the channel image, the near-zero channel values being identified as channel values exceeding the delay threshold.

7. The BS of claim 6, wherein the processor is further configured to:
identify, based on power of the set of pixels in the channel images, the identified path from the path clusters; and
generate, based on the identified path, a sequence for the channel tracking operation.

8. A method of a base station (BS) in a wireless communication system, the method comprising:
receiving one or more sounding reference signals (SRSs);
identifying, based on the one or more SRSs, path clusters of channel instances, wherein each of the path clusters includes a group of paths that have associated impinging angles and propagation delays, respectively;
identifying, based on a set of pixels in a channel image, a path from the path clusters; and
performing, based on the identified path, a channel tracking operation.

9. The method of claim 8, further comprising identifying the set of pixels in an impinging angle domain and a propagation delay domain,
wherein each pixel in the set of pixels is separately processed for the path clusters.

10. The method of claim 8, wherein:
the channel tracking operation is performed in an antenna-frequency domain, an angle-delay domain, and a path-cluster domain;
an SRS channel estimation and an SRS channel usage are performed in the antenna-frequency domain;
an angle-delay transformation and an inverse transformation are performed in the angle-delay domain; and
a channel reconstruction operation is performed, based on an artificial intelligence (AI) prediction model, using a path sequence in the path-cluster domain.

11. The method of claim 10, further comprising:
identifying the set of pixels in the channel image during an observation window time;
performing, based on the set of pixels identified during the observation window time, a prediction operation for the set of pixels in the channel image during a prediction window time; and
generating, based on the set of pixels and the predicted set of pixels, a set of training samples for the AI prediction model.

12. The method of claim 11, wherein the observation window time is associated with a channel state information (CSI) observation window time in order to reduce a sparsity of the one or more SRSs in a time domain.

13. The method of claim 8, further comprising:
identifying a delay threshold in a delay domain to adjust a number of tracking paths for the channel tracking operation; and
removing near-zero channel values in the channel image, the near-zero channel values being identified as channel values exceeding the delay threshold.

14. The method of claim 13, further comprising:
identifying, based on power of the set of pixels in the channel images, the identified path from the path clusters; and
generating, based on the identified path, a sequence for the channel tracking operation.

15. A non-transitory computer-readable medium comprising program code, that when executed by at least one processor, causes an electronic device to:
receive one or more sounding reference signals (SRSs);
identify, based on the one or more SRSs, path clusters of channel instances, wherein each of the path clusters includes a group of paths that have associated impinging angles and propagation delays, respectively,
identify, based on a set of pixels in a channel image, a path from the path clusters; and
perform, based on the identified path, a channel tracking operation.

16. The non-transitory computer-readable medium of claim 15, further comprising program code, that when executed by at least one processor, causes an electronic device to identify the set of pixels in an impinging angle domain and a propagation delay domain,
wherein each pixel in the set of pixels is separately processed for the path clusters.

17. The non-transitory computer-readable medium of claim 15, wherein:
the channel tracking operation is performed in an antenna-frequency domain, an angle-delay domain, and a path-cluster domain;
an SRS channel estimation and an SRS channel usage are performed in the antenna-frequency domain;
an angle-delay transformation and an inverse transformation are performed in the angle-delay domain; and
a channel reconstruction operation is performed, based on an artificial intelligence (AI) prediction model, using a path sequence in the path-cluster domain.

18. The non-transitory computer-readable medium of claim 17, further comprising program code, that when executed by at least one processor, causes an electronic device to:
identify the set of pixels in the channel image during an observation window time;
perform, based on the set of pixels identified during the observation window time, a prediction operation for the set of pixels in the channel image during a prediction window time; and
generate, based on the set of pixels and the predicted set of pixels, a set of training samples for the AI prediction model,
wherein the observation window time is associated with a channel state information (CSI) observation window time in order to reduce a sparsity of the one or more SRSs in a time domain.

19. The non-transitory computer-readable medium of claim 15, further comprising program code, that when executed by at least one processor, causes an electronic device to:
identify a delay threshold in a delay domain to adjust a number of tracking paths for the channel tracking operation; and
remove near-zero channel values in the channel image, the near-zero channel values being identified as channel values exceeding the delay threshold.

20. The non-transitory computer-readable medium of claim 19, further comprising program code, that when executed by at least one processor, causes an electronic device to:
identify, based on power of the set of pixels in the channel images, the identified path from the path clusters; and
generate, based on the identified path, a sequence for the channel tracking operation.
